(19) United States
(12) Patent Application Publication
(10) Pub. No.: US 2018/0283969 A1
(43) Pub. Date: Oct. 4, 2018

(54) HIGH RESOLUTION POLARIZED LOW-COHERENCE INTERFERENCE PRESSURE MEASUREMENT DEVICE AND METHOD THEREOF

(71) Applicant: Tianjin University, Tianjin (CN)

(72) Inventors: Shuang WANG, Tianjin (CN); Tiegen LIU, Tianjin (CN); Junfeng JIANG, Tianjin (CN); Mengnan XIAO, Tianjin (CN); Kun LIU, Tianjin (CN); Pan HE, Tianjin (CN)

(73) Assignee: Tianjin University, Tianjin (CN)

(21) Appl. No.: 15/565,421

(22) PCT Filed: Oct. 27, 2016
(86) PCT No.: PCT/CN2016/103524

§ 371 Date: Oct. 9, 2017

(30) Foreign Application Priority Data
Dec. 28, 2015 (CN) 201511016364.X

(51) Int. Cl. G01L 9/00

(52) U.S. Cl. CPC G01L 9/0032

(57) ABSTRACT

The present invention discloses a high-resolution polarized low-coherence interference pressure measurement device and method, which comprise a broadband light source (1), an optical fiber coupler (2), an optical fiber Fabry-Perot sensor (3), a collimating lens (4), a polarizer (5), a birefringence wedge (6) having a spatial dip angle, an analyzer (7), a matrix camera (8), and a signal processing unit (9), which are successively provided from an input end to an output end; wherein light emitted from the broadband light source (1) passes through the optical fiber coupler (2) and arrives at the optical fiber Fabry-Perot sensor (3), and returned light emitted from the optical fiber Fabry-Perot sensor (3) is led into a demodulation interferometer; a change in pressure is transformed into a change in length of a Fabry-Perot cavity by the optical fiber Fabry-Perot sensor (3), and different pressures correspond to different lengths of the Fabry-Perot cavity; the collimating lens (4), the polarizer (5), the birefringence wedge (6) having a spatial dip angle, the analyzer (7), and the matrix camera (8) together form a demodulation interferometer; the collimating lens (4) is disposed at the forefront end of the demodulation interferometer to converge and collimate light beams; input signal light collimated by the collimating lens is polarized by the polarizer (5); and the linearly polarized light passes through the birefringence wedge (6) having a spatial dip angle to generate two orthogonal linearly polarized lights which have a optical path difference linearly distributed along the thickness variation direction of the optical wedge; thus achieving low-coherence interferometric fringes zooming to different extents in horizontal and vertical directions by a two-dimensional angle of the birefringence wedge (6) having a spatial dip angle. The present invention also discloses a method for measuring pressure of a high-resolution polarized low-coherence interference system.

### TECHNICAL FIELD

The present invention belongs to the technical field of optical fiber sensing, and in particular to high-resolution polarized low-coherence interference pressure measurement device and method thereof based on a matrix camera.

### BACKGROUND OF THE PRESENT INVENTION

In 1983, for the first time, Al-Chalabi et al. (S. A. Al-Chalabi, B. Culshaw, D. E. N. Davies, Partially coherent sources in interferometric sensors, First International Conference on Optical Fibre Sensors, 1983: 26 to 28) put forward a demodulation method based on low-coherence interferometry in the field of optical fiber sensing. The types of demodulation interferometers based on the low-coherence interferometry are mainly included mechanical-scanning interferometers and electronic-scanning interferometers. An ultimate purpose of the two types of interferometers is to generate optical path differences in the time axis or the space axis. When a certain optical path difference generated by a demodulation interferometer is matched with that generated by a microcavity of a sensor, a peak of low-coherence interferometric fringes will be generated. The peak position is calculated to obtain the length of a Fabry-Perot cavity by demodulation, and to further obtain the external physical variables leading to change in the length of the Fabry-Perot cavity.

As the electronic-scanning polarized low-coherence interference system generates an optical path difference in space by a birefringent crystal, such low-coherence interference system, without any moving parts, has advantages such as compact structure and high stability. The existing electronic-scanning polarized low-coherence interference demodulation systems collects low-coherence interferometric fringes by a liner photodetector (for example, a liner CCD), and the demodulation method are generally carried out on the basis of one-dimensional low-coherence interferometric fringes. When pressure is measured by the length of the microcavity of the optical fiber Fabry-Perot pressure sensor, the measurement range and measurement resolution thereof are limited by the size and number of pixels of the detector. Generally, a tradeoff decision has to be made between the two important indicators, i.e., the measurement range and the measurement resolution. Since it is difficult to achieve the two important indicators (i.e., a wide range and a high resolution) simultaneously, the polarized low-coherence interferometric demodulation systems are applied in a limited range.

### SUMMARY OF THE PRESENT INVENTION

In view of the above problems in the prior art, the present invention provides a high-resolution polarized low-coherence interference pressure measurement device and method thereof, by which 2D low-coherence interferometric fringes are acquired by a 2D electronic-scanning demodulation interferometer, and a pressure sensing and demodulation method having both a wide measurement range and a high resolution is achieved by the optical lever effect of a birefringence wedge having a spatial dip angle.

The present invention provides a high-resolution polarized low-coherence interference pressure measurement device, comprising a broadband light source 1, an optical fiber coupler 2, an optical fiber Fabry-Perot sensor 3, a collimating lens 4, a polarizer 5, a birefringence wedge 6 having a spatial dip angle, an analyzer 7, a matrix camera 8, and a signal processing unit 9, which are successively provided from an input end to an output end, wherein, light emitted from the broadband light source 1 passes through an optical fiber coupler 2 and arrives at the optical fiber Fabry-Perot sensor 3, and the returned light emitted from the optical fiber Fabry-Perot sensor 3 is led into an interferometric demodulation optical path; a change in pressure is transformed into a change in length of a Fabry-Perot cavity by the optical fiber Fabry-Perot sensor 3, and different pressures correspond to different lengths of the Fabry-Perot cavity; the collimating lens 4, the polarizer 5, the birefringence wedge 6 having a spatial dip angle, the analyzer 7 and the matrix camera 8 together form an interferometric demodulator; the collimating lens 4 is disposed at the forefront end of the interferometric demodulation optical path to converge and collimate light beams; input signal light collimated by the collimating lens is polarized by the polarizer 5; and the linearly polarized light passes through the birefringence wedge 6 having a spatial dip angle to generate two orthogonal linearly polarized lights which have a spatial optical path difference linearly distributed along the thickness variation direction of the optical wedge; thus achieving low-coherence interferometric fringes zooming to different extents in horizontal and vertical directions by a two-dimensional spatial angle of the birefringence wedge 6 having a spatial dip angle; and expanding the measurement ranges via compressing the interferometric fringes in one direction; and improving the measurement resolution via broadening the local interferometric fringes in the other direction; the two orthogonal linearly polarized light are projected by the analyzer 7 in a same direction and generate interferometric fringes; and then the generated interferometric fringes are collected by the matrix camera 8 and are processed by the signal processing unit 9 to finally obtain a pressure measurement result.

The present invention further provides a method for measuring pressure of a high-resolution polarized low-coherence interference system, including the following steps:

Step 1: light emitted from a broadband light source passes through an optical fiber coupler and arrives at an optical fiber Fabry-Perot sensor;

Step 2: a light signal modulated by the optical fiber Fabry-Perot sensor emits from the outlet of the coupler, and collimates by a collimating lens, then goes through a polarizer to polarize to linearly polarized light; then the light enters into a birefringence wedge having a spatial dip angle; wherein a polarization axis of the polarizer and an optical axis of the birefringence wedge having a spatial dip angle are placed in 45 degrees; in the birefringence wedge having a spatial dip angle, the polarized light is divided into two orthogonal linearly polarized light, i.e., o-light and e-light; and the two components generate an optical path difference in the birefringence wedge having a spatial dip angle, the expression is as follows:

l(x,y)=d(x,y)·(nₑ−nₒ),

Wherein, x is a transverse distance from a light incident point to an apex of the wedge, y is a longitudinal distance from a light incident point to the apex of the wedge, nₒ and nₑ are refraction indexes of o-light and e-light of a birefringent crystal, respectively, d(x, y) represents the wedge thickness at the light incident point, expressed by:

d(x,y)=x tan θ+y tan φ+d₀,

Wherein, and θ are φ angles of the optical wedge in the horizontal and vertical directions, respectively, and d₀ is the thickness of the optical wedge at a fixed point thereof;

Thus expanding the measurement ranges by designing a wide angle in one direction for compressing the interferometric fringes, and improving the measurement resolution by designing a small angle in the other direction for broadening the local interferometric fringes;

Step 3: the light passes through the analyzer which is placed in an angle of 45 degrees to an optical axis of the birefringence wedge with a spatial dip angle, and superposes the orthogonal o-light and e-light which are transmitted through the birefringence wedge having a spatial dip angle in a polarization detecting direction to generate interferometric fringes which are then received by a matrix camera;

Step 4: the two-dimensional interferometric fringe signal output by the matrix camera is processed by the signal processing unit; the rough peak position is obtained through the low-coherence interferometric signal in the direction of the large angle; based on coordinates of the rough peak position, through the low-coherence interferometric signal in the direction of the small angle, the precise peak position of the fringe is obtained to finally extract the length information of a Fabry-Perot cavity and to obtain a corresponding pressure measurement result, thus achieving the high-resolution pressure demodulation.

The present invention effectively forms an optical lever by using the birefringent effect, achieves zooming the low-coherence interferometric fringes to different extents in horizontal and vertical directions by designing a two-dimensional spatial angle of a birefringence wedge having a spatial dip angle. Compared with the prior art, the present invention adopts a spatial angle of the birefringence wedge in the vertical direction and utilizes the matrix camera for receiving the signal, thus the pressure demodulation having both a wide measurement range and a high resolution.

### BRIEF DESCRIPTION OF THE DRAWINGS

FIG. 1 is a schematic structure diagram of a high resolution polarized low-coherence interference pressure measurement device based on a matrix camera;

FIG. 2 is a schematic structure diagram of a birefringence wedge having a spatial dip angle;

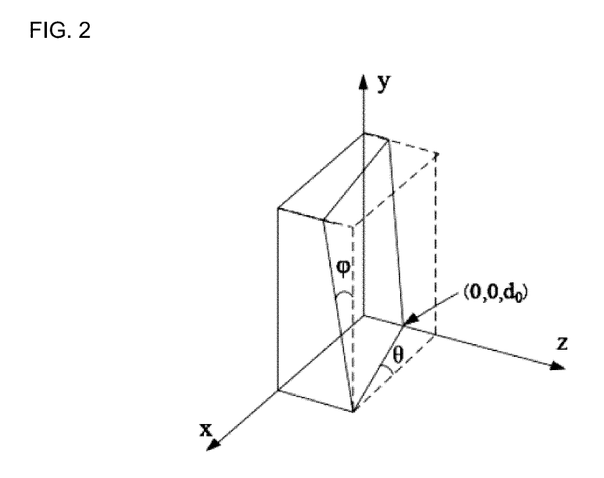

FIG. 3 shows a single frame experimental result at four pressure points of 11 kPa, 55 kPa, 101 kPa and 255 kPa, received by a matrix camera;

FIG. 4 shows the original data of a certain frame image in line 1020 and column 1044 under 101 kPa;

FIG. 5 shows a fluctuation diagram of the result of processing data in line 1020 of 150 images under 101 kPa;

FIG. 6 shows a fluctuation diagram of the result of processing data in column 1044 of 150 images under 101 kPa.

In which:

1: broadband light source; 2: optical fiber coupler; 3: optical fiber Fabry-Perot sensor; 4: collimated lens; 5: polarizer; 6: birefringence wedge having a spatial dip angle; 7: analyzer; 8: matrix camera; and 9: signal processing unit.

### DETAILED DESCRIPTION OF THE PREFERRED EMBODIMENTS

### Embodiment 1

A High-Resolution Polarized Low-Coherence Interference Pressure Measurement Device Based on a Matrix Camera

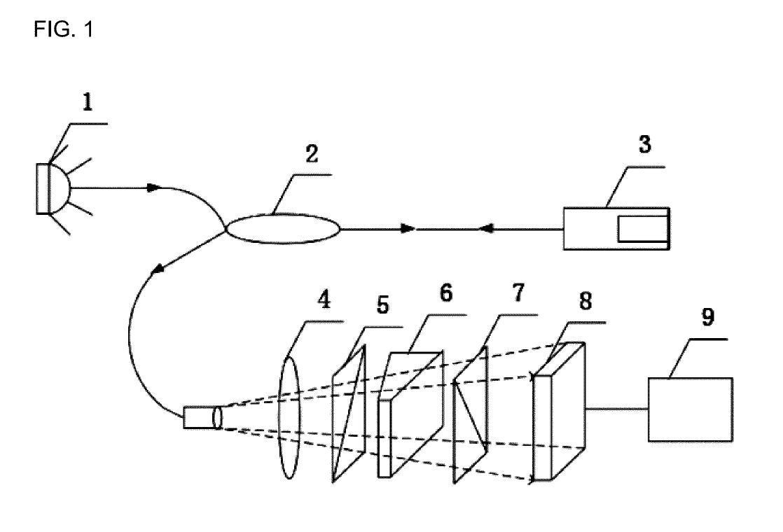

As shown in FIG. 1, light emitted from a broadband light source 1 passes through an optical fiber coupler 2 and arrives at an optical fiber Fabry-Perot sensor 3, and the signal modulated by the optical fiber Fabry-Perot sensor 3 is led out from the outlet of the optical fiber coupler 2, and collimates by a collimating lens 4, then goes through a demodulation interferometer which is formed of a polarizer 5, a birefringence wedge 6 having a spatial dip angle and an analyzer 7; due to the birefringence wedge 6 having a spatial dip angle is provided with the birefringent effect, light goes through the birefringence wedge 6 having a spatial dip angle and forms a low-coherence interferometric fringes and are received by a matrix camera 8; then the interferometric fringe signals output by the matrix camera 8 are processed by a signal processing unit 9; and when the optical path difference generated by the birefringence wedge 6 having a spatial dip angle is matched with that generated by the optical fiber Fabry-Perot sensor 3, obvious low-coherence interferometric fringes will be generated in a corresponding local part of the matrix camera 8.

During this experiment, the broadband light source 1 is a SLED light source module with a central wavelength of 750 nm, the optical fiber coupler 2 is a 2×2 multimode coupler, the polarizer 5 and the analyzer 7 are Glan Thompson prisms, the birefringence wedge 6 having a spatial dip angle is made of LiNbO3, and the matrix camera 8 adopts a matrix CCD which the size of the pixels thereof being 3.45 μm*3.45 μm and the number of pixels being 2456*2058.

### Embodiment 2

A High-Resolution Polarized Low-Coherence Interference Pressure Measurement Method Based on a Matrix Camera

The above method for measuring pressure is as follows:

Step 1: light emitted from a broadband light source 1 passes through an optical fiber coupler 2 and arrives at an optical fiber Fabry-Perot sensor 3 which is configured to sense atmospheric pressure; and two reflecting surfaces of the Fabry-Perot cavity form a sensing interferometer, and the distance between the two reflecting surfaces of the Fabry-Perot cavity are linearly related to the atmospheric pressure.

Step 2: a light signal modulated by the optical fiber Fabry-Perot sensor 3 is led out from the outlet of the optical fiber coupler 2, and collimates by a collimating lens 4, then goes through a polarizer 5 to be linearly polarized light; then, the light enters into a birefringence wedge 6 having a spatial dip angle; wherein a polarization axis of the polarizer 5 and an optical axis of the birefringence wedge 6 having a spatial dip angle are placed in 45 degrees; in the birefringence wedge 6 having a spatial dip angle, the polarized light is divided into two orthogonal linearly polarized light, i.e., o-light and e-light, both of which have different optical paths in spite of a same transmission distance; and the two components generate an optical path difference in the birefringence wedge 6 having a spatial dip angle, the expression is as follows: l(x,y)=d(x,y)·(nₑ−nₒ), wherein, x is a transverse distance from a light incident point to an apex of the wedge, y is a longitudinal distance from a light incident point to the apex of the wedge, nₒ and nₑ are refraction indexes of o-light and e-light of a birefringent crystal, respectively, d(x, y) represents the wedge thickness at the light incident point, expressed by: d(x,y)=x tan θ+y tan φ+d₀, wherein, and θ are φ angles of the optical wedge in the horizontal and vertical directions, respectively, and d₀ is the thickness of the optical wedge at a fixed point thereof; the present invention achieves zooming the low-coherence interferometric fringes to different extents in horizontal and vertical directions by adopting the birefringent effect which is provided by the birefringence wedge 6 having a spatial dip angle, and expands the measurement ranges via compressing the interferometric fringes in one direction; and improves the measurement resolution via broadening the local interferometric fringes in the other direction; during the experiment, the angle θ of the LiNbO3 wedge in the horizontal direction is 4°, and the angle φ in the vertical direction is 1°, d₀=1.5 mm, so the wedge thickness corresponding to a certain point on a receiving surface of the matrix camera 8 can be expressed by:

d(x,y)=x tan 4°+y tan 1°+1.5 mm≈0.0699x+0.0175y+1.5 mm.

Step 3: the light passes through the analyzer 7 which is placed in an angle of 45 degrees to an optical axis of the birefringence wedge 6 having a spatial dip angle, and superposes the orthogonal o-light and e-light which are transmitted through the birefringence wedge 6 having a spatial dip angle in a polarization detecting direction to generate interferometric fringes which are then received by the matrix camera 8;

Step 4: the two-dimensional interferometric fringe signal output by the matrix camera 8 is processed by the signal processing unit 9. First, in the direction of a wide angle, i.e., the horizontal direction, the signal processing unit 9 extracts the line data, and obtains a rough peak position by processing a low-coherence interferometric signal in the direction of the wide angle; based on coordinates of the rough peak position, the signal processing unit 9 extracts column data in the direction of the small wedge angle, i.e., the vertical direction; and by processing the low-coherence interferometric signal in the direction of the small angle obtains the precise peak position of the fringe, thus finally extracting the length information of an Fabry-Perot cavity, obtaining a corresponding pressure measurement result, and achieving the high-resolution pressure demodulation.

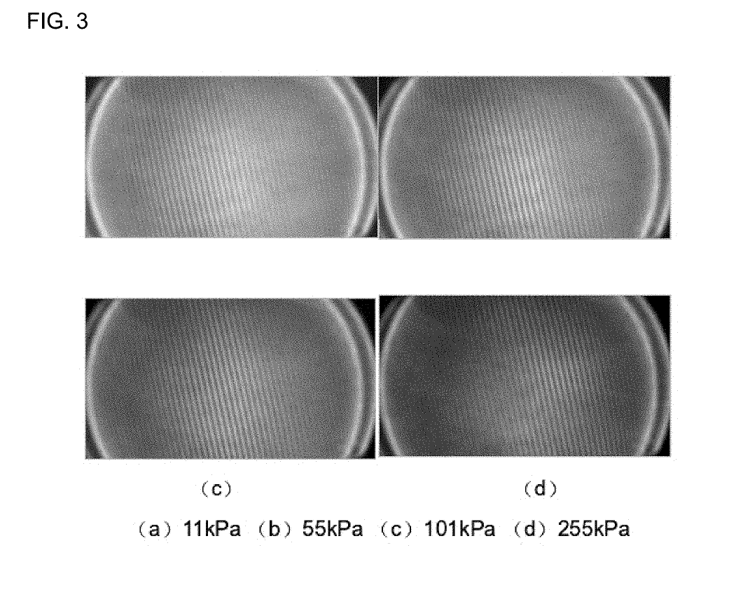

During the experiment, the optical fiber Fabry-Perot sensor is placed in a pressure chamber, with a pressure change ranges from 5 kPa to 265 kPa and a changing step of 2 kPa. FIG. 3 shows a single experiment result at four pressure points of 11 kPa, 55 kPa, 101 kPa and 255 kPa, received by a matrix camera. FIG. 3 clearly shows that the position of central fringes is moving in a single direction with the change in pressure.

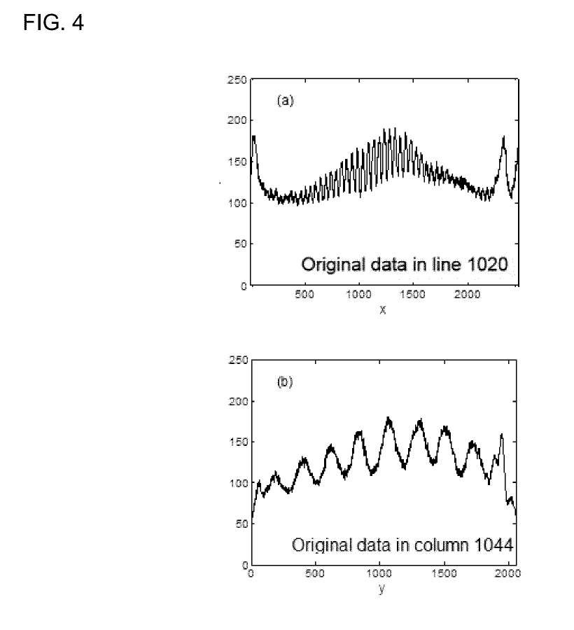

By extracting data in the line 1020 (the original signal is as shown in FIG. 4(a)) in a certain image (FIG. 3(c)) under a pressure of 101 kPa, data in the line 1020, the position x at the maximum value of the central fringe is 1044, i.e., the position of the fringe peak is roughly positioned near the 1044^{th} pixel in this line; based on the rough peak position, performing analysis in the vertical direction, and selecting the signal in column 1044 (the original signal is as shown in FIG. 4(b)) for processing, and performing calculation to achieve that a relatively precise position at the maximum value of the central fringe is at the 1077^{th} pixel in this column.

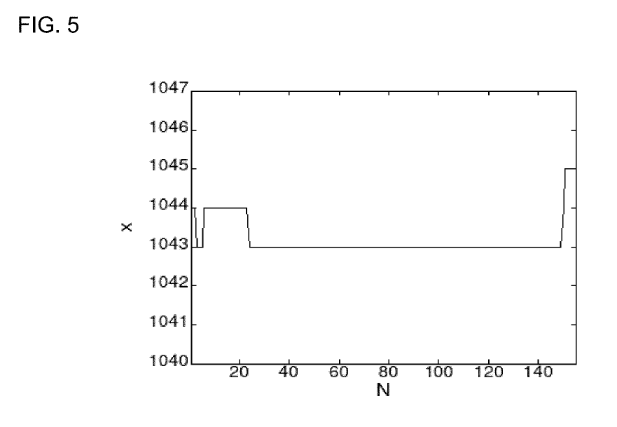

With regard to 150 images obtained under 101 kPa, signals in line 1020^{th} are extracted for processing. As shown in FIG. 5, the position at the maximum value of the central fringe is within the ranges from 1043^{th} to the 1046^{th} pixels in this line, the corresponding change in the length of the Fabry-Perot cavity is 0.03 μm, thus the position of the fringe peak can be roughly positioned.

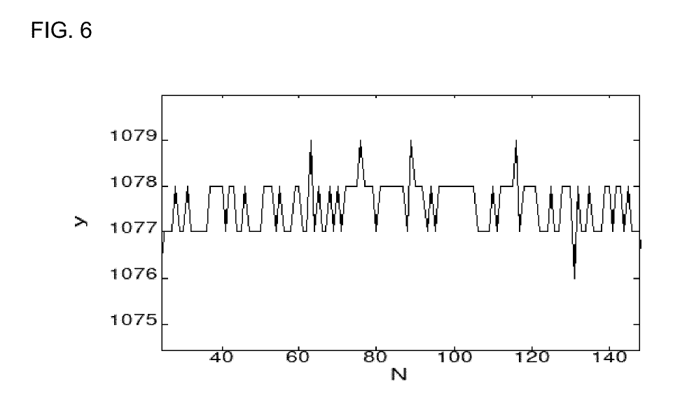

With regard to 150 images obtained under 101 kPa, signals in column 1044^{th} are extracted for processing. As shown in FIG. 6, the position at the maximum value of the central fringe is within the range from 1077^{th} to the 1079^{th} pixels in this column, the corresponding change in the length of the Fabry-Perot cavity is 0.005 μm. The measurement result shows that the measured cavity length values have small fluctuation, thus improving the demodulation resolution.

In the high-resolution polarized low-coherence interference system based on a matrix camera of the present invention:

The broadband light source may be an LED light source or an SLD light source;

The birefringent crystal may be LiNbO3 crystal, MgF2 crystal, calcite crystal or YVO4 crystal;

The polarizer and the analyzer may be polarizing prisms such as a Glan Taylor prism and a Glam Thompson prism, or a polarizer sheet;

The matrix camera may be a matrix CMOS camera or a matrix CCD;

The processing unit may be implemented by an embedded system, in addition to a computer; and

The optical fiber devices and optical devices may be replaced with corresponding space optical devices.

What is claimed is:

1. A high-resolution polarized low-coherence interference pressure measurement device, comprising a broadband light source (1), an optical fiber coupler (2), an optical fiber Fabry-Perot sensor (3), a collimating lens (4), a polarizer (5), a birefringence wedge (6) having a spatial dip angle, an analyzer (7), a matrix camera (8), and a signal processing unit (9), which are successively provided from an input end to an output end, wherein, light emitted from the broadband light source (1) passes through the optical fiber coupler (2) and arrives at the optical fiber Fabry-Perot sensor (3), and returned light emitted from the optical fiber Fabry-Perot sensor (3) is led into an demodulation optical path; a change in pressure is transformed into a change in length of a Fabry-Perot cavity by the optical fiber Fabry-Perot sensor (3), and different pressures correspond to different lengths of the Fabry-Perot cavity; the collimating lens (4), the polarizer (5), the birefringence wedge (6) having a spatial dip angle, the analyzer (7), and the matrix camera (8) together form a demodulation interferometer; the collimating lens (4) is disposed at the forefront end of the demodulation interferometer to converge and collimate light beams; input signal light collimated by the collimating lens is polarized by the polarizer (5); and the linearly polarized light passes through the birefringence wedge (6) having a spatial dip angle to generate two orthogonal linearly polarized lights which have a spatial optical path difference linearly distributed along the thickness variation direction of the optical wedge; thus achieving low-coherence interferometric fringes zooming to different extents in horizontal and vertical directions by a two-dimensional angle of the birefringence wedge (6) having a spatial dip angle, and expanding the measurement ranges via compressing the interferometric fringes in one direction, and improving the measurement resolution via broadening the local interferometric fringes in the other direction; the two orthogonal linearly polarized light are projected by the analyzer (7) in a same direction and generate interferometric fringes; and then the generated interferometric fringes are collected by the matrix camera (8) and are processed by the signal processing unit (9) to finally obtain a pressure measurement result.

2. A method for measuring pressure of a high-resolution polarized low-coherence interference system, comprising the following steps:
Step 1: light emitted from a broadband light source passes through an optical fiber coupler and arrives at an optical fiber Fabry-Perot sensor;
Step 2: a light signal modulated by the optical fiber Fabry-Perot sensor emits from the outlet of the coupler and collimates by a collimating lens, then goes through a polarizer to be linearly polarized light; then the light enters into a birefringence wedge having a spatial dip angle; wherein a polarization axis of the polarizer and an optical axis of the birefringence wedge having a spatial dip angle are placed in 45 degrees; in the birefringence wedge having a spatial dip angle, the polarized light is divided into two orthogonal linearly polarized light, i.e., o-light and e-light; and two components generate an optical path difference in the birefringence wedge having a spatial dip angle, the expression is as follows:
l(x,y)=d(x,y)·(nₑ−nₒ),
Wherein, x is a transverse distance from a light incident point to an apex of the wedge, y is a longitudinal distance from a light incident point to the apex of the wedge, nₒ and nₑ are refraction indexes of o-light and e-light of a birefringent crystal, respectively, d(x, y) represents the wedge thickness at the light incident point, expressed by:
d(x,y)=x tan θ+y tan φ+d₀,
Wherein, and θ are φ angles of the optical wedge in the horizontal and vertical directions, respectively, and d₀ is the thickness of the optical wedge at a fixed point thereof;
Thus expanding the measurement ranges by designing a wide angle in one direction for compressing the interferometric fringes, and improving the measurement resolution by designing a small angle in the other direction for broadening the local interferometric fringes;
Step 3: the light passes through the analyzer which is placed in an angle of 45 degrees to an optical axis of the birefringence wedge having a spatial dip angle, and superposes the orthogonal o-light and e-light which are transmitted through the birefringence wedge having a spatial dip angle in a polarization detecting direction to generate interferometric fringes which are then received by a matrix camera;
Step 4: the two-dimensional interferometric fringe signal output by the matrix camera is processed by the signal processing unit; the rough peak position is obtained through the low-coherence interferometric signal in the direction of the large angle; based on coordinates of the rough peak position, through the low-coherence interferometric signal in the direction of the small angle, the precise peak position of the fringe is obtained to finally extract the length information of an Fabry-Perot cavity and to obtain a corresponding pressure measurement result, thus achieving the high-resolution pressure demodulation.
